(19) United States
(12) Patent Application Publication
(10) Pub. No.: US 2003/0183801 A1
(43) Pub. Date: Oct. 2, 2003

(54) Porous oxygen scavenging material

(76) Inventors: Hu Yang, San Ramon, CA (US); Ta Yen Ching, Novato, CA (US); Lennard Torres, Pleasanton, CA (US)

Correspondence Address: WILLIAMS, MORGAN & AMERSON, P.C., 10333 RICHMOND, SUITE 1100, HOUSTON, TX, 77042, US

(21) Appl. No.: 10/109,266

(22) Filed: Mar. 28, 2002

(51) Int. Cl. C09K 3/00

(52) U.S. Cl. 252/188.28

(57) ABSTRACT

Oxygen scavenging compositions and packaging and methods of producing the same. A first material comprising a blow agent and an oxidizable organic polymer having a polymeric backbone and cyclic olefinic groups is exposed to an elevated temperature and/or pressure sufficient to cause the oxidizable organic polymer to melt and the blow agent to evolve gas, thus creating micro-voids within the polymer material. Such porous oxygen scavenging materials can have a increased oxygen scavenging rate, when compared to oxygen scavenging materials of similar composition that have a non-porous structure.

### BACKGROUND OF THE INVENTION

1. Field of the Invention

The present invention relates generally to the field of oxygen scavenging polymers. More particularly, it concerns oxygen scavenging compositions and packaging articles comprising a porous plastic structure.

2. Description of Related Art

It is known that limiting the exposure of oxygen-sensitive products to oxygen maintains and enhances the quality and shelf-life of the packaged product. One method of limiting oxygen exposure involves incorporating an oxygen scavenger into a packaging structure such as a film or coating. Incorporation of a scavenger into such packaging structures promotes the interception and reaction with oxygen that passes through the package walls from either the outside or the inside of the package.

For instance, corrosion caused by oxidation can be avoided or reduced when certain electronic and electrical devices are packaged or encapsulated in oxygen scavenging films. In another example, the quality of an oxygen-sensitive food product can be maintained, or onset of food spoilage can be either avoided or delayed, by limiting the food's exposure to oxygen. This can, for example, be achieved by packaging a fresh food in a package comprising an oxygen scavenging coating.

Plastics comprising oxygen scavenging polymers which have a low glass transition temperature (T_{g}), tend to be relatively amorphous and rubbery. Oxygen diffusion can occur faster in such polymers than in more crystalline oxygen scavenging plastic compositions, thus permitting oxygen scavenging to occur at a faster rate. However, the oxygen scavenging rate can still be limited for polymers having a relatively low T_{g} due to the relatively low amount of surface area available for the oxygen to react with oxygen scavenger. Restated the rate at which a scavenging material reacts with or adsorbs oxygen can be dependent on the structure of the plastic itself. In many oxygen sensitive food packaging applications, it is desirable to reduce the oxygen content within the package in as short a period of time as possible in order to minimize damage to the food that occurs initially after packing. The damage to sensitive foods due to the presence of relatively high concentrations of oxygen in the package that occurs immediately after packaging can be significant. An oxygen scavenging system with a significantly improved scavenging rate, and a higher scavenging capacity available immediately following packaging of an oxygen sensitive material, is thus highly desirable. Polymeric materials that have a porous or foam structure are known in the art, and such polymers have been used in preparing packaging both because (1) they afford a package with certain required mechanical properties (e.g., cushioning as with egg cartons and insulation as in foam cups) and/or (2) they reduce the cost of the package (e.g., less polymer required per unit volume). Porous polymeric materials have also been used as packing materials in chromatography columns, and as components in filtering devices. These applications rely at least in part on the properties of the porous polymeric materials to aid in the separation of different chemicals.

Packaging that has a fast oxygen scavenging rate is desirable for food and beverage packaging applications, among others.

### SUMMARY OF THE INVENTION

Certain embodiments of the present invention are directed to a method of preparing a porous oxygen scavenging composition, which can, in certain cases, be an oxygen scavenging foam. A first material comprising a blow agent and an oxidizable organic polymer is exposed to an elevated temperature and/or pressure. Either the temperature, the pressure, or both are sufficient to cause the polymer to melt. There are two broad categories of blow agents used in preparing foamed plastics, and they are: physical blow agents, and chemical blow agents. Physical blow agents can include nitrogen carbon dioxide and chlorofluorocarbons (CFCs), among others. Such gases are injected into a plastic melt in the screw barrel under pressure, and a cellular structure is produced, when the polymer melt is reduced to atmospheric pressure or a lower pressure. Similarly, volatile liquids, such as aliphatic hydrocarbons or chlorinated hydrocarbons, are also widely used, these volatile liquids are gaseous under the conditions of processing a polymer melt, and thereby produce cells within the plastic. The chemical blow agents are generally solid materials, and are used to evolve gas within a defined temperature range in the melt process, usually referred as the decomposition temperature range. Preferably when the blow agent is a chemical blow agent, the temperature and pressure at which the oxidizable organic compound is processed is sufficient to cause gas to evolve from the decomposition of the agent. The chemical blow agents can include organic or inorganic compounds, such as sodium bicarbonate or sulphonyl hydrazide compounds, and which can be used in the present invention. It is known in the art that certain chemical blow agents are compatible for use with certain polymers The chemical blow agent and the polymer that is being processed have to be compatible chemically, and the chemical blow agent must be capable of gassing at a temperature that are required to process the oxygen scavenging polymers that is being foamed. Preferably the expanded cells created in an oxidizable polymer to form the porous oxygen scavenging composition have an average diameter of between about 1 and 20 microns.

The oxidizable organic polymer that is a component of the first material comprises a polymeric backbone and a plurality of pendant groups having the formula (I)

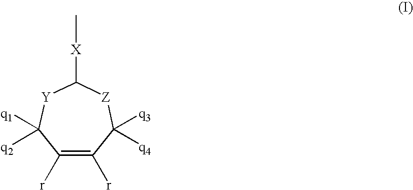

X is a C₁-C₁₂ alkyl; a substituted C₁-C₁₂ alkyl; a C₁-C₁₂ ester; a C₁-C₁₂ ether; a C₁-C₁₂ silicone; or a group with the structure —(CH₂)ₙ—M—(CH₂)ₘ, wherein M is a linkage comprising oxygen, nitrogen, sulfur, silicon, or any combination thereof; n is from 0 to 12, inclusive; and m is from 0 to 12, inclusive, provided that when one of n or m is 0, the other is at least 1. Y is —(CRR′)ₐ—, wherein a is 0, 1, or 2; and Z is —(CRR′)_{b}—, wherein b is 0, 1, or 2, provided that 1≦a+b≦3. q₁, q₂, q₃, q₄, r, R, and R′ are independently selected from hydrogen; linear, branched, cyclic, or polycyclic C₁-C₂₀ alkyl; aromatic groups; halogens; amines; and sulfur-containing substituents. Preferably q₀, q₁, q₂, q₃, q₄, r, R, and R′ are hydrogen, a is 0, and b is 1.

In certain embodiments, the first material can further comprise at least one of additional polymers, transition metal catalysts, photoinitiators, colorants, antioxidants, and antimicrobial agents.

Certain embodiments of the present invention are directed to porous or foamed oxygen scavenging compositions prepared using methods described above, while other embodiments are directed to packaging articles comprising such porous or foamed oxygen scavenging compositions. A porous oxygen scavenging composition is defined as a composition whose apparent density is decreased substantially (e.g., 10% or greater reduction in density) by the presence of numerous cells disposed throughout its mass. In this invention the terms porous, foamed, or cellular oxygen scavenging compositions are used interchangeably to denote all two-phase gas-solid oxygen scavenging compositions in which the solid is continuous and composed of an oxygen scavenging polymer.

Certain embodiments of the present invention are directed to an article that comprises a polymeric structure having micro-voids therein, wherein the structure comprises an oxidizable organic polymer, as described above. The foamed oxygen scavenging composition can have a density substantially less than that of an oxygen scavenging composition that has not been processed using a blow agent. Preferably the oxygen scavenging composition has a density less than 0.7 g/cm³. Preferably the micro-voids have an average diameter of between about 1 micron and 20 microns. The micro-voids (e.g., cells) in the foamed oxygen scavenging composition can be in the form of either open cell or closed cell, or both.

The scavenging rates of oxygen scavenging compositions can be limited by the surface area available for reaction with oxygen, since the ability of a scavenging material to react with oxygen depends in part on the structure of the scavenging material, and how readily oxygen diffuses through it. Compositions of the present invention having porous or micro-void structures (e.g., closed or open cells within their structure) can have increased surface area available for reaction with of oxygen, when compared to similar oxygen compositions that are non-porous. In fact, the surface area available for reaction with oxygen in the porous compositions of the present invention can be substantially greater than similar compositions that do not have micro-voids. The introduction of micro-voids into the matrix of an oxygen scavenging composition, as in the present invention, can be used to produce packaging with an increased scavenging rate, when compared to oxygen scavengers of similar composition that lack such micro-voids. The higher scavenging rate results in a larger amount of oxygen being consumed in a given amount of time. Thus, food and beverage packaging comprising compositions of the present invention can, for example, have a faster reduction of oxygen content within packaging than can be attained using oxygen scavenging non-porous packaging known in the art.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 depicts a graph in which non-porous and porous oxygen scavenging compositions are compared in their ability to scavenge oxygen from air over time at room temperature.

FIG. 2 depicts a graph in which non-porous and porous oxygen scavenging compositions are compared in their ability to scavenge 1% oxygen over time at 4° C.

### DESCRIPTION OF ILLUSTRATIVE EMBODIMENTS

Certain embodiments of the present invention are directed to preparing a porous oxygen scavenging composition. An oxidizable organic polymer is preferably blended with a blow agent to produce a first material.

The oxidizable organic polymer comprises a polymeric backbone and a plurality of pendant groups. Preferably the polymeric backbone comprises a substantially saturated hydrocarbon backbone. A substantially saturated hydrocarbon backbone comprises no more than about 0.1% carbon-carbon double bonds, preferably less than about 0.01%, and most preferably the backbone is 100% saturated. The polymeric backbone can comprise monomers of ethylene or styrene. More preferably, the polymeric backbone is ethylenic. One preferred oxidizable organic compound is ethylene/vinyl cyclohexene copolymer (EVCH).

The oxidizable organic polymer can also comprise substituted hydrocarbon moieties which can include, but are not limited to, those with oxygen-containing moieties, such as esters, carboxylic acids, aldehydes, ethers, ketones, alcohols, peroxides, or hydroperoxides. Specific examples of such hydrocarbons include, but are not limited to, condensation polymers such as polyesters derived from monomers containing carbon-carbon double bonds; unsaturated fatty acids such as oleic, ricinoleic, dehydrated ricinoleic, and linoleic acids and derivatives thereof, e.g. esters. Such hydrocarbons also include polymers or copolymers derived from (meth)allyl (meth)acrylates. Exemplary oxygen scavenging polymers include those described by Ching et al., International Patent Publication WO99/48963.

As described above, the oxidizable organic polymer comprises a polymeric backbone and at least one cyclic olefinic pendant group. The pendant groups have formula (I).

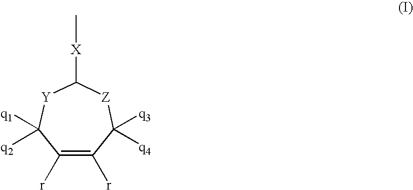

In formula (I), X is a C₁-C₁₂ alkyl; a substituted C₁-C₁₂ alkyl; a C₁-C₁₂ ester; a C₁-C₁₂ ether; a C₁-C₁₂ silicone; or a group with the structure —(CH₂)ₙ—M—(CH₂)ₘ, wherein M is a linkage comprising oxygen, nitrogen, sulfur, silicon, or any combination thereof. n is from 0 to 12, inclusive; and m is from 0 to 12, inclusive, provided that when one of n or m is 0, the other is at least 1; Y is —(CRR′)ₐ—, wherein a is 0, 1, or 2; and Z is —(CRR′)_{b}—, wherein b is 0, 1, or 2, provided that 1≦a+b≦3. q₁, q₂, q₃, q₄, r, R, and R′ are independently selected from hydrogen; linear, branched, cyclic, or polycyclic C₁-C₂₀ alkyl; aromatic groups; halogens; amines; or sulfur-containing substituents. Preferably the pendant groups comprise a cyclohexenyl moiety, e.g., q₀, q₁, q₂, q₃, q₄, r, R, and R′ are hydrogen, a is 0, and b is 1.

While other oxygen scavenging materials known in the art, such as ethylenically unsaturated compounds (e.g. polymers having unsaturation in their backbones and or in non-cyclic olefinic pendant groups), can be used in certain embodiments of the present, they can introduce undesirable characteristics into the packaging. As an example, oxidation of an ethylenically unsaturated polymer backbone can result in fragmentation of the polymer backbone leading to chain secession, thus weakening the physical integrity of a package comprising such an oxygen scavenging polymer. Furthermore, packaging that comprises oxygen scavenging unsaturated compounds such as squalene or vegetable oils can produce large amounts of volatile aldehydes and ketones upon oxidation. Many of such volatile compounds can diffuse from the packaging structure and find their way into the head space of the package. Such oxidation by-products can contaminate packaged comestible products giving them an off-odor and/or taste. Likewise oxygen scavenging polymers having non-cyclic olefinic pendant groups that react with oxygen can produce undesirable by-products during scavenging. Preferred oxidizable organic polymers used in methods, compositions, and packaging of the present invention comprise an ethylenic backbone and a cyclic olefinic pendant group. The cyclic olefinic pendant group reacts with oxygen, and its reaction does not result in fragmentation. Thus, preferred oxidizable organic polymers of the present invention can maintain the structural integrity of the packaging that comprises them, while avoiding the problem of imparting oxidation by-products to a packaged material, because there is no significant fragmentation of the olefinic pendant groups, the linking groups, or the polymeric backbone as a result of oxidation.

Preferably, the polymer comprises a linking group, X in formula I, linking the backbone with the cyclic alkenyl moiety, wherein the linking group is selected from:

—O—(CHR)ₙ—; —(C═O)—O—(CHR)ₙ—; —NH—(CHR)ₙ—; —O—(C═O)—(CHR)ₙ—; —(C═O)—NH—(CHR)ₙ—; or —(C═O)—O—CHOH—CH₂—O—;

wherein R is hydrogen, methyl, ethyl, propyl, or butyl; and n is an integer from 1 to 12, inclusive.

Preferably, the oxidizable organic polymer is ethylene/methyl acrylate/cyclohexenyl methyl acrylate terpolymer (EMCM) or cyclohexenylmethyl acrylate (CHAA) homopolymer. Ethylene/methyl acrylate/cyclohexenyl methyl acrylate terpolymer (EMCM)is a most preferred oxidizable organic polymer (e.g., oxygen scavenging polymer). EMCM can be readily made following the teachings of copending U.S. patent application Ser. No. 09/127,316, incorporated herein by reference. The porous oxygen scavenging compositions of the present invention can also comprise a mixture of two or more oxygen scavenging polymers as described above.

The first material, which comprises the blow agent and the oxidizable organic polymer preferably comprises greater than about 80 wt % of the oxidizable organic polymer, more preferably greater than about 90 wt %, and most preferably greater than about 95 wt % of the oxidizable organic polymer.

The chemical blow agent that is a component of the first material can be any known in the art. Preferably the first material comprises between 0.05 and 1 wt % of the blow agent. Physical blow agents are known in the art, and that can be used in the present invent include: nitrogen, CFCs, or carbon dioxide gas, and volatile hydrocarbon liquids. These physical blow agents are gaseous at the temperature and pressures used to process the oxidizable organic polymer. The blow agent that is to be combined with the oxidizable organic polymer can, in certain embodiments, be introduced directly or can be introduced in the form of a master batch during the melt process

Preferably the chemical blow agent used can be decomposed to produce a gas at the temperature used to process the polymer present in the first material. Preferably the blow agent is one based on azodicarbonamide, dinitroso pentamethylene tetramine, or sulfonyl, among others. More preferably the blow agent is based on 4,4′-oxybis (benzyl sulphonyl hydrazide) (OBSH), azodicarbonic acid diamide (ADC), or p-toluene sulphonyl hydrazide (TSH). When the first material is exposed to an elevated temperature and/or pressure, that is sufficient to cause both (i) polymer present in the first material to melt and (ii) the chemical blow agent to evolve a gas, a plurality of cells (e.g., micro-voids) are created within the exposed material. For example, in a composition comprising EMCM and an OBSH based blow agent, the composition can be extruded at a temperature of 190° C., which is sufficient both the melt EMCM and to cause the decomposition of the blow agent, such that a gas is produced. When the pressure on the exposed material is reduced to atmospheric pressure or to a pressure lower than that in the extruder, the cells within the material expand, and a porous oxygen scavenging composition is produced. Preferably, the porous oxygen scavenging material produced comprises expanded cells having an average diameter of between about 1 and 20 microns. The size of the micro-voids can be adjusted using methods known in the art. The selection of blow agent and the processing conditions are taken into account by those skilled in the art, when preparing porous structures with micro-voids of differing mean sizes. The size and number of the micro-voids can also affect, optical, mechanical and rheological properties of the polymer, as is known in the art. Foaming of the polymer (e.g., production of micro-voids (e.g., cells) within the polymer composition) using chemical blow agents can be performed during extrusion, molding, or during other polymer processing steps known in the art. The physical blow agents, including nitrogen, carbon dioxide, CFCs or liquid hydrocarbons can also be used in producing the foamed oxygen scavenging composition during the melt process.

In addition to the oxidizable organic polymer and the blow agent, the first material can further comprise at least one of additional polymers, transition metal catalysts, photoinitiators, colorants, antioxidants, and antimicrobial agents.

Additional polymers can be components of the first mixture, and they can be introduced before or after exposure to elevated temperature and/or pressure in order to modify the physical properties of the porous oxygen scavenging polymer product (e.g., opacity, rheology, flexibility, processing temperature, among others). Such polymers can include polyolefins including polyethylene methyl acrylate copolymer (EMAC), among others.

Preferably, the first material comprises at least one transition metal catalyst. Though not to be bound by theory, useful catalysts include those which can readily interconvert between at least two oxidation states. See Sheldon, R. A.; Kochi, J. K.; “Metal-Catalyzed Oxidations of Organic Compounds” Academic Press, New York 1981.

Preferably, the catalyst is in the form of a salt, with the transition metal selected from the first, second or third transition series of the Periodic Table. Suitable metals and their oxidation states include, but are not limited to, manganese II or III, iron II or III, cobalt II or III, nickel II or III, copper I or II, rhodium II, III or IV, and ruthenium. The oxidation state of the metal when introduced need not necessarily be that of the active form. The metal is preferably iron, nickel, manganese, cobalt or copper; more preferably manganese or cobalt; and most preferably cobalt. Suitable counterions for the metal include, but are not limited to, chloride, acetate, stearate, palmitate, 2-ethylhexanoate, neodecanoate or naphthenate. Preferably, the salt, the transition metal, and the counterion are either on the U.S. Food and Drug Administration GRAS (generally regarded as safe) list, or exhibit substantially no migration from a packaging article comprising the compositions of the present invention to the product (i.e. less than about 500 ppb, preferably less than about 50 ppb, in the product). Particularly preferable salts include cobalt 2-ethylhexanoate, cobalt oleate, cobalt stearate, and cobalt neodecanoate. The metal salt can also be an ionomer, in which case a polymeric counterion is employed. Such ionomers are well known in the art.

Typically, the amount of transition metal catalyst, as a metal cation, may range from 0.001 to 1% (10 to 10,000 ppm) of the porous oxygen scavenging composition, based on the metal content only (excluding ligands, counterions, etc.). Antioxidants may be used with this invention to provide shelf-life stability or process stability, or to control scavenging initiation. An antioxidant as defined herein is a material which inhibits oxidative degradation or cross-linking of polymers. Typically, antioxidants are added to facilitate the processing of polymeric materials or prolong their useful lifetime. In relation to this invention, such additives can prolong the induction period for oxygen scavenging. When it is desired to commence oxygen scavenging by a packaging article comprising the porous oxygen scavenging composition, the packaging article can be exposed to heat or UV.

Antioxidants such as 2,6-di(t-butyl)-4-methylphenol(BHT), 2,2′-methylene-bis(6-t-butyl-p-cresol), triphenylphosphite, tris-(nonylphenyl)phosphite and dilaurylthiodipropionate are suitable for use in the porous oxygen scavenging composition of this invention.

The amount of an antioxidant which may be present can also have an effect on scavenging. Antioxidants can be present in oxygen scavenging polymers or structural polymers to prevent oxidation or gelation of the polymers. Typically, they are present in about 0.01 to 1% by weight of the porous oxygen scavenging composition.

The composition can, preferably, comprise a photoinitiator. If use of a photoinitiator is desired, appropriate photoinitiators include benzophenone derivatives containing at least two benzophenone moieties, as described in U.S. Pat. No. 6,139,770 which was filed May 16, 1997, and issued on Oct. 31, 2000. These compounds act as effective photoinitiators to initiate oxygen scavenging activity in porous oxygen scavenging compositions. Because of their large size and low solubility, such benzophenone derivatives have a very low degree of extraction from oxygen scavenging compositions, which can lead to reduced contamination of a packaged product by extracted photoinitiator.

A “benzophenone moiety” is a substituted or unsubstituted benzophenone group. Suitable substituents include alkyl, aryl, alkoxy, phenoxy, and alicylic groups contain from 1 to 24 carbon atoms or halides.

The benzophenone derivatives include dimers, trimers, tetramers, and oligomers of benzophenones and substituted benzophenones.

The benzophenone photoinitiators are represented by the formula:

Aₘ(B)ₙ

wherein A is a bridging group selected from sulfur; oxygen; carbonyl; —SiR₂—, wherein each R is individually selected from alkyl groups containing from 1 to 12 carbon atoms, aryl groups containing 6 to 12 carbon atoms, or alkoxy groups containing from 1 to 12 carbon atoms; —NR′—, wherein R′ is an alkyl group containing 1 to 12 carbon atoms, an aryl group containing 6 to 12 carbon atoms, or hydrogen; or an organic group containing from 1 to 50 carbon atoms, preferably from 1 to 40 carbon atoms; m is an integer from 0 to 11; B is a substituted or unsubstituted benzophenone group; and n is an integer from 2 to 12.

A can be a divalent group, or a polyvalent group with 3 or more benzophenone moieties. The organic group, when present, can be linear, branched, cyclic (including fused or separate cyclic groups), or an arylene group (which can be a fused or non-fused polyaryl group). The organic group can contain one or more heteroatoms, such as oxygen, nitrogen, phosphorous, silicon, or sulfur, or combinations thereof. Oxygen can be present as an ether, ketone, ester, or alcohol.

The substituents of B, herein R″, when present, are individually selected from alkyl, aryl, alkoxy, phenoxy, or alicylic groups containing from 1 to 24 carbon atoms, or halides. Each benzophenone moiety can have from 0 to 9 substituents. Substituents can be selected to render the photoinitiator more compatible with the oxygen scavenging composition.

Examples of such benzophenone derivatives comprising two or more benzophenone moieties include dibenzoyl biphenyl, substituted dibenzoyl biphenyl, benzoylated terphenyl, substituted benzoylated terphenyl, tribenzoyl triphenylbenzene, substituted tribenzoyl triphenylbenzene, benzoylated styrene oligomer (a mixture of compounds containing from 2 to 12 repeating styrenic groups, comprising dibenzoylated 1,1-diphenyl ethane, dibenzoylated 1,3-diphenyl propane, dibenzoylated 1-phenyl naphthalene, dibenzoylated styrene dimer, dibenzoylated styrene trimer, and tribenzoylated styrene trimer), and substituted benzoylated styrene oligomer. Tribenzoyl triphenylbenzene (BBP³) and substituted tribenzoyl triphenylbenzene are especially preferred.

The amount of photoinitiator in the porous oxygen scavenging composition, when used, will be in the range of about 0.01% to about 10%, preferably about 0.01% to about 1%, by weight of the porous oxygen scavenging composition.

The amounts of the components used in porous oxygen scavenging compositions or packaging articles that comprise them can effect their oxygen scavenging abilities. Thus, the amounts of oxygen scavenging polymer, transition metal catalyst, and any photoinitiator, antioxidant, structural polymers, and additives, can vary depending on a composition's or packaging article's end use.

For instance, the primary function of an oxygen scavenging polymer in an oxygen scavenging composition is to react irreversibly with oxygen during the scavenging process, while the primary function of a transition metal catalyst is to facilitate this process. Thus, to a large extent, the amount of oxygen scavenging polymer will affect the oxygen capacity of the composition, i.e., affect the amount of oxygen that the composition can consume. The amount of transition metal catalyst will affect the rate at which oxygen is consumed. Because it primarily affects the scavenging rate, the amount of transition metal catalyst may also affect the induction period.

Certain embodiments of the present invention are directed to an article that comprises a polymeric structure having micro-voids therein. The structure comprises an oxidizable organic polymer, as described above. It can further comprise additional polymers, transition metal catalysts, photoinitiators, colorants, antioxidants, antimicrobial agents, as described above. The foamed oxygen scavenging composition can have a density substantially less (e.g., 10% or greater reduction) than that of an oxygen scavenging composition processed without a blow agent, and a foamed oxygen scavenger can have an increased oxygen scavenging rate. Preferably the oxygen scavenging composition has a density less than 0.7 g/cm³. As described above, it is preferred that the micro-voids have an average diameter of between about 1 micron and 20 microns. The micro-voids (e.g., cells) in the foamed oxygen scavenging composition can be in the form of either open-cell or closed cell, or both.

Porous oxygen scavenging materials of the present invention can be used in a number of different packaging structures that can comprise either single or multiple layers. For example a tray can be made using an oxygen scavenging foam of the present invention. Alternatively, an artificial cork as a closure for a wine bottle can be made having a porous oxygen scavenging polymeric core peripherally surrounded and integrally bonded with a cooperating synthetic plastic, extruded, outer layer. Closures for a wine bottle comprising a porous composition of the present invention can also comprise antimicrobial agents to enhance the shelf-life and quality of the wine. A porous structure of the present invention could also be applied to the inside of a jar lid or bottle cap. It might also be used as a component in a layer in the wall of a container, such as a bottle wall. The compositions of the present invention can also be used to prepare inserts that can be used in packaging.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLES

Material.

In the following examples, EMCM (DS 4720 R) is an oxidizable organic polymer from Chevron Phillips Chemical Co., as described above. The EMAC based cobalt master batch comprised EMAC (DS 4560 M), 1 wt. % tribenzoyl triphenylbenzene (BBP³) and 1 wt % cobalt as cobalt oleate (all from Chevron Phillips Chemical Co.). The blow agent used to produce the oxygen scavenging compositions having a porous microstructure in the resin was BLO-FOAM OBSH, which was provided by Rit-Chem, and which comprises 4,4′-oxybis (benzyl sulphonyl hydrazide) that decomposes at elevated temperatures to produce a gas.

In order to demonstrate the accelerated oxygen scavenging performance that correlates with incorporation of micro-voids within the oxygen scavenger, micro-voids (cells) were produced in oxygen scavenging resins by the incorporation of small amounts of a blow agent in the starting material followed by exposure of the material to elevated temperatures (e.g., 190° C.). Three compositions were compounded, and their oxygen scavenging performance was compared. The first composition was a non-porous composition prepared without a blow agent. The second and third compositions were similar to the control composition, but further comprised blow agent, at 0.5% and 1% respectively, and the resulting compositions had a micro porous structure.

| | EMCM | | Blow Agent | |
|---|---|---|---|---|
| | Oxidizable | Oxidation Catalyst | BLO-FOAM | |
| | Polymer | Master batch | OBSH | Remark |
| Example 1 | 90.00 wt % | 10.00 wt % | None | Standard- |
| | | | | control |
| Example 2 | 89.55 wt % | 9.95 wt % | 0.50 wt % | Foamed |
| | | | | Structure |
| Example 3 | 89.11 wt % | 9.90 wt % | 0.99 % | Foamed |
| | | | wt % | Structure |

Methods.

All of the melt compounding of materials described in these experiments was done using the Haake Rheocord 90 twin screw extruder. A flat temperature profile (Zone 1-Zone 4 at 190° C.) and a screw speed of 45 RPM was used for all the compositions described in the examples. The polymer strand from the extruder was pelletized. Headspace oxygen scavenging by the pelletized sample was determined using a MOCON Model 450 Headspace Analyzer. The compositions oxygen scavenging was triggered by exposing the samples to 800 mJ of UV light at a wavelenth of 254 nm.

### Example 1

The Control (Non-porous) Oxygen Scavenging Composition

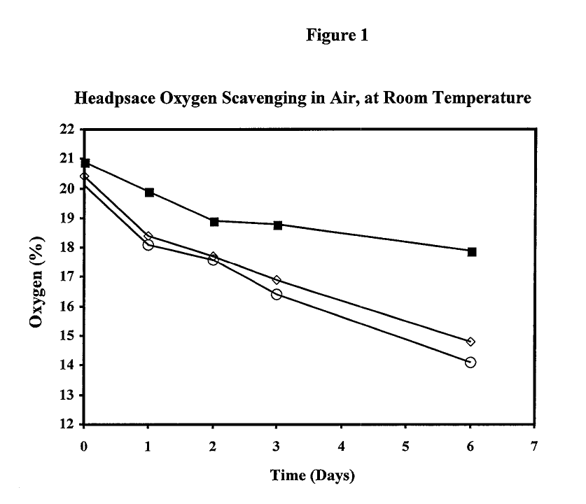

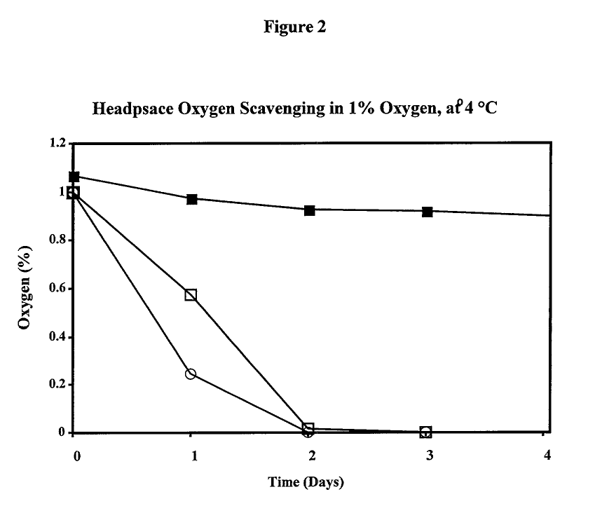

A mixture of 90 parts of EMCM pellets and 10 parts of catalyst master batch pellets was compounded on the Haake Rheocord 90 at a flat temperature (Zones 1-4 were set at 190° C. with a screw speed of 45 rpm). The polymer strand was then pelletized. A 1.00 gram sample of the pellet was sealed in an aluminum bag and filled with 300 cc of air. The sealed bag was placed at room temperature and the headspace oxygen was monitored by taking 5 cc of gas from the bag at various time intervals. In parallel tests, a 1.00 gram sample of the pellet was sealed in an aluminum bag and the bag was filled with 300 CC of 1% oxygen in nitrogen. The sealed aluminum bag was stored at 4° C. The headspace gases were evaluated over time by withdrawing 5 cc of gas from the bag and evaluating the sample on a Mocon Model 450 Headspace Analyzer. Thus, oxygen scavenging performance of a sample stored at a lower temperature and having a lower oxygen concentration was also evaluated. The oxygen scavenging ability under both conditions is illustrated in FIGS. 1 and 2. The symbol ▪ represents the oxygen scavenging compositions of this control example in the figures.

### Example 2

Oxygen Scavenging Composition with 0.5% Blow Agent

A mixture of, 100 parts of the compounded pellets obtained from example 1 and 0.5 parts of blow agent dissolved in a minimum amount of methylene chloride, were mixed in an container. The mixture was then dried under vacuum to remove the solvent. The dried mixture was then compounded on the Haake Rheocord 90 at a flat temperature (Zones 1-4 was set at 190° C. with a screw speed of 45 rpm). The strand obtained was pelletized. In order to evaluate the oxygen scavenging rate of the composition, 1.00 gram of pellet sample was sealed in an aluminum bag, and the bag was filled with 300 cc of air. The sealed bag was stored at room temperature during testing. The decrease in oxygen concentration over time was analyzed by taking 5 cc of gas from the bag at different time intervals and analyzing the samples on a Mocon 450 Headspace Analyzer. In addition, 1.00 gram of pellet was sealed in an aluminum bag with 300 cc of 1% oxygen in nitrogen and stored at 4° C. The oxygen scavenging rate at low temperature for this composition was evaluated, and is depicted in FIGS. 1 and 2. The composition prepared with 0.5% blow agent is represented by the symbol ⋄.

### Example 3

Oxygen Scavenging Composition with 1% Blow Agent

The sample preparation and the subsequent testing were similar to the Example 2, except that 1% blow agent was used in preparing the composition. The oxygen scavenging rate is depicted for tests at room temperature and at 4° C. in FIGS. 1 and 2, in which the composition is represented by the symbol ◯.

Based on the oxygen scavenging performance of each of the compositions, standard non-porous oxygen scavenging compositions of Example 1 had a slower oxygen scavenging rate both (i) at room temperature in air and (ii) at 4° C. with 1% oxygen, than compositions which had been formulated with a blow agent at 0.5% and at 1.0% (e.g., Examples 2 and 3).

Thus oxygen scavenging polymer having porous structures can be used in applications in which a faster oxygen scavenging rate is desirable. Such packaging applications that would benefit from rapid oxygen scavenging rates include beverage, fruit and medicine packaging.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the method described herein without departing from the concept, spirit and scope of the invention. More specifically, it will be apparent that certain agents which are both chemically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A method of preparing a porous oxygen scavenging composition comprising:
providing a first material comprising a blow agent and an oxidizable organic polymer, wherein the oxidizable organic polymer comprises a polymeric backbone and a plurality of pendant groups having the formula (I) 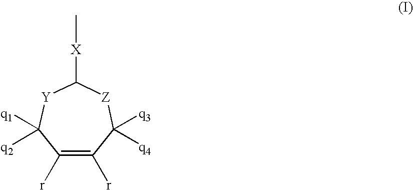
wherein X is a C₁-C₁₂ alkyl; a substituted C₁-C₁₂ alkyl; a C₁-C₁₂ ester; a C₁-C₁₂ ether; a C₁-C₁₂ silicone; or a group with the structure —(CH₂)ₙ—M—(CH₂)ₘ, wherein M is a linkage comprising oxygen, nitrogen, sulfur, silicon, or any combination thereof; n is from 0 to 12, inclusive; and m is from 0 to 12, inclusive, provided that when one of n or m is 0, the other is at least 1; Y is —(CRR′)ₐ—, wherein a is 0, 1, or 2; and Z is —(CRR′)_{b}13 , wherein b is 0, 1, or 2, provided that 1≦a+b≦3; and q₁, q₂, q₃, q₄, r, R, and R′ are independently selected from hydrogen; linear, branched, cyclic, or polycyclic C₁-C₂₀ alkyl; aromatic groups; halogens; amines; or sulfur-containing substituents; and
exposing the first material to a temperature and to a pressure sufficient to cause the polymer to melt, thereby creating a plurality of cells within the exposed material.

2. The method of claim 1, further comprising the step of permitting the plurality of cells to expand thereby producing a porous oxygen scavenging composition.

3. The method of claim 2, wherein the porous oxygen scavenging composition comprises expanded cells having an average diameter of between about 1 and 20 microns, and wherein the cells comprise open cells, closed cells, or both.

4. The method of claim 2, wherein the blow agent is a chemical blow agent that produces a gas at the temperature sufficient to cause the polymer to melt.

5. The method of claim 2, wherein the blow agent is a physical blow agent selected from the group consisting of nitrogen, carbon dioxide, and hydrocarbons that are volatile at the temperature sufficient to cause the polymer to melt.

6. The method of claim 2, wherein the porous oxygen scavenging composition has a density less than about 0.7 g/cm³.

7. The method of claim 2, wherein the porous oxygen scavenging composition has a density that is substantially less than that of the oxidizable polymer without blow agent.

8. The method of claim 1, wherein q₀, q₁, q₂, q₃, q₄, r, R, and R′ are hydrogen, a is 0, and b is 1.

9. The method of claim 1, wherein the first material comprises greater than about 80 wt % the oxidizable organic polymer.

10. The method of claim 1, wherein the polymeric backbone is ethylenic.

11. The method of claim 1, wherein the X is selected from
—O—(CHR)ₙ—; —(C═O)—O—(CHR)ₙ—; —NH—(CHR)ₙ—; —O—(C═O)—(CHR)ₙ—; —(C═O)—NH—(CHR)ₙ—; or —(C═O)—O—CHOH—CH₂—O—;
wherein R is hydrogen, methyl, ethyl, propyl, or butyl; and n is an integer from 1 to 12, inclusive.

12. The method of claim 1, wherein the oxidizable organic compound is ethylene/methyl acrylate/cyclohexenyl methyl acrylate terpolymer (EMCM) or cyclohexenylmethyl acrylate (CHAA) homopolymer.

13. The method of claim 1, wherein the blow agent comprises at least one compound selected from the group consisting of 4,4′-oxybis (benzyl sulphonyl hydrazide), azodicarbonic acid diamide, and p-toluene sulphonyl hydrazide.

14. The method of claim 1, wherein the first material further comprises at least one of additional polymers, transition metal catalysts, photoinitiators, colorants, antioxidants, and antimicrobial agents.

15. The method of claim 14, wherein the first material comprises a transition metal catalyst and the catalyst comprises a transition metal selected from the group consisting of cobalt, copper, manganese, iron, nickel, rhodium, and ruthenium.

16. The method of claim 15, wherein the transition metal catalyst is cobalt oleate, cobalt stearate, or cobalt neodecanoate.

17. The method of claim 14, wherein the first material comprises a photoinitiator selected from the group consisting of dibenzoyl biphenyl, substituted dibenzoyl biphenyl, benzoylated terphenyl, tribenzoyl triphenylbenzene, and benzoylated styrene oligomer.

18. The method of claim 1, wherein the first material is blended during the exposing step.

19. The method of claim 1, wherein the blow agent is a chemical blow agent, and wherein the agent is dissolved in a solvent and blended with the oxidizable organic polymer, and the blend comprising the solvent, the blow agent, and the oxidizable organic polymer is dried at a temperature below that sufficient to cause the blow agent to evolve gas in order to remove substantially all of the solvent, thereby producing the first material.

20. A porous oxygen scavenging composition, wherein the composition is prepared by a method comprising the steps of:
providing a first material comprising a blow agent and an oxidizable organic polymer, wherein the oxidizable organic polymer comprises a polymeric backbone and a plurality of pendant groups having the formula (I) 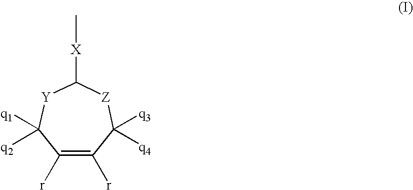
wherein X is a C₁-C₁₂ alkyl; a substituted C₁-C₁₂ alkyl; a C₁-C₁₂ ester; a C₁-C₁₂ ether; a C₁-C₁₂ silicone; or a group with the structure —(CH₂)ₙ—M—(CH₂)ₘ, wherein M is a linkage comprising oxygen, nitrogen, sulfur, silicon, or any combination thereof; n is from 0 to 12, inclusive; and m is from 0 to 12, inclusive, provided that when one of n or m is 0, the other is at least 1; Y is —(CRR′)ₐ—, wherein a is 0, 1, or 2; and Z is —(CRR′)_{b}—, wherein b is 0, 1, or 2, provided that 1≦a+b≦3; and q₁, q₂, q₃, q₄, r, R, and R′ are independently selected from hydrogen; linear, branched, cyclic, or polycyclic C₁-C₂₀ alkyl; aromatic groups; halogens; amines; or sulfur-containing substituents; and exposing the first material to an elevated temperature sufficient to cause the polymer to melt, thereby creating a plurality of cells within the exposed material.

21. The composition of claim 20, the method further comprising the step of permitting the plurality of cells to expand, thereby producing a porous oxygen scavenging composition.

22. The composition of claim 21, wherein the porous oxygen scavenging composition comprises expanded cells having an average diameter of between about 1 and 20 microns, and wherein the cells comprise open cells, closed cells, or both.

23. The composition of claim 21, wherein the blow agent is a chemical blow agent that produces a gas at the elevated temperature.

24. The composition of claim 21, wherein the blow agent is a physical blow agent selected from the group consisting of nitrogen, carbon dioxide, and hydrocarbons that are volatile at the elevated temperature.

25. The composition of claim 21, wherein the porous oxygen scavenging composition has a density less than about 0.7 g/cm³.

26. The method of claim 21, wherein the porous oxygen scavenging composition has a density that is substantially less than that of the oxidizable polymer without blow agent.

27. The composition of claim 20, wherein q₀, q₁, q₂, q₃, q₄, r, R, and R′ are hydrogen, a is 0, and b is 1.

28. The composition of claim 20, wherein the first material comprises greater than about 80 wt % the oxidizable organic polymer.

29. The composition of claim 20, wherein the polymeric backbone is ethylenic.

30. The composition of claim 20, wherein the X is selected from
—O—(CHR)ₙ—; —(C═O)—O—(CHR)ₙ—; —NH—(CHR)ₙ—; —O—(C═O)—(CHR)ₙ—; —(C═O)—NH—(CHR)ₙ—; or —(C═O)—O—CHOH—CH₂—O—;
wherein R is hydrogen, methyl, ethyl, propyl, or butyl; and n is an integer from 1 to 12, inclusive.

31. The composition of claim 20, wherein the oxidizable organic compound is ethylene/methyl acrylate/cyclohexenyl methyl acrylate terpolymer (EMCM) or cyclohexenylmethyl acrylate (CHAA) homopolymer.

32. The composition of claim 20, wherein the blow agent comprises at least one compound selected from the group consisting of 4,4′-oxybis (benzyl sulphonyl hydrazide), azodicarbonic acid diamide, and p-toluene sulphonyl hydrazide.

33. The composition of claim 20, wherein the first material further comprises at least one of additional polymers, transition metal catalysts, photoinitiators, colorants, antioxidants, and antimicrobial agents.

34. The composition of claim 33, wherein the first material comprises a transition metal catalyst and the catalyst comprises a transition metal selected from the group consisting of cobalt, copper, manganese, iron, nickel, rhodium, and ruthenium.

35. The composition of claim 34, wherein the transition metal catalyst is cobalt oleate, cobalt stearate, or cobalt neodecanoate.

36. The composition of claim 33, wherein the first material comprises a photoinitiator selected from the group consisting of dibenzoyl biphenyl, substituted dibenzoyl biphenyl, benzoylated terphenyl, tribenzoyl triphenylbenzene, and benzoylated styrene oligomer.

37. The composition of claim 20, wherein the first material is blended during the exposing step.

38. The composition of claim 20, wherein the blow agent is a chemical blow agent and wherein the agent is dissolved in a solvent and blended with the oxidizable organic polymer, and the blend comprising the solvent, the blow agent, and the oxidizable organic polymer is dried at a temperature below that sufficient to cause the blow agent to evolve gas in order to remove substantially all of the solvent, thereby producing the first material.

39. A packaging article comprising:
a porous oxygen scavenging composition, wherein the composition is prepared by a method comprising the steps of:
providing a first material comprising a blow agent and an oxidizable organic polymer, wherein the oxidizable organic polymer comprises a polymeric backbone and a plurality of pendant groups having the formula (I) 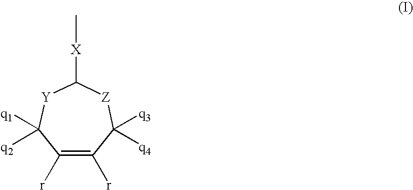
wherein X is a C₁-C₁₂ alkyl; a substituted C₁-C₁₂ alkyl; a C₁-C₁₂ ester; a C₁-C₁₂ ether; a C₁-C₁₂ silicone; or a group with the structure —(CH₂)ₙ—M—(CH₂)ₘ, wherein M is a linkage comprising oxygen, nitrogen, sulfur, silicon, or any combination thereof; n is from 0 to 12, inclusive; and m is from 0 to 12, inclusive, provided that when one of n or m is 0, the other is at least 1; Y is —(CRR′)ₐ—, wherein a is 0, 1, or 2; and Z is —(CRR′)_{b}—, wherein b is 0, 1, or 2, provided that 1 ≦a+b≦3; and q₁, q₂, q₃, q₄, r, R, and R′ are independently selected from hydrogen; linear, branched, cyclic, or polycyclic C₁-C₂₀ alkyl; aromatic groups; halogens; amines; or sulfur-containing substituents; and
exposing the first material to an elevated temperature sufficient to cause the polymer to melt, thereby creating a plurality of cells within the exposed material.

40. The packaging article of claim 39, wherein the method further comprises the step of permitting the plurality of cells to expand, thereby producing a porous oxygen scavenging composition.

41. The packaging article of claim 40, wherein the porous oxygen scavenging composition comprises expanded cells having an average diameter of between about 1 and 20 microns, and wherein the cells comprise open cells, closed cells, or both.

42. The packaging article of claim 40, wherein the blow agent is a chemical blow agent that produces a gas at the elevated temperature.

43. The packaging article of claim 40, wherein the blow agent is a physical blow agent selected from the group consisting of nitrogen, carbon dioxide, and hydrocarbons that are volatile at the elevated temperature.

44. The packaging article of claim 40, wherein the porous oxygen scavenging composition has a density less than about 0.7 g/cm³.

45. The packaging article of claim 40, wherein the porous oxygen scavenging composition has a density that is substantially less than that of the oxidizable polymer without blow agent.

46. The packaging article of claim 39, wherein the packaging article comprises a single layer.

47. The packaging article of claim 39, wherein the packaging article comprises more than one layer.

48. The packaging article of claim 39, wherein the packaging article is a tray, a component of a closure for a bottle or jar, or an insert.

49. The packaging article of claim 39, wherein q₀, q₁, q₂, q₃, q₄, r, R, and R′ are hydrogen, a is 0, and b is 1.

50. The packaging article of claim 39, wherein the first material comprises greater than about 80 wt % the oxidizable organic polymer.

51. The packaging article of claim 39, wherein the polymeric backbone is ethylenic.

52. The packaging article of claim 39, wherein the X is selected from
—O—(CHR)ₙ—; —(C═O)—O—(CHR)ₙ—; —NH—(CHR)ₙ—; —O—(C═O)—(CHR)ₙ—; —(C═O)—NH—(CHR)ₙ—; or —(C═O)—O—CHOH—CH₂—O—;
wherein R is hydrogen, methyl, ethyl, propyl, or butyl; and n is an integer from 1 to 12, inclusive.

53. The packaging article of claim 39, wherein the oxidizable organic compound is ethylene/methyl acrylate/cyclohexenyl methyl acrylate terpolymer (EMCM) or cyclohexenylmethyl acrylate (CHAA) homopolymer.

54. The packaging article of claim 39, wherein the blow agent comprises at least one compound selected from the group consisting of 4,4′-oxybis (benzyl sulphonyl hydrazide), azodicarbonic acid diamide, and p-toluene sulphonyl hydrazide.

55. The packaging article of claim 39, wherein the first material further comprises at least one of additional polymers, transition metal catalysts, photoinitiators, colorants, antioxidants, and antimicrobial agents.

56. The packaging article of claim 55, wherein the first material comprises a transition metal catalyst and the catalyst comprises a transition metal selected from the group consisting of cobalt, copper, manganese, iron, nickel, rhodium, and ruthenium.

57. The packaging article of claim 56, wherein the transition metal catalyst is cobalt oleate, cobalt stearate, or cobalt neodecanoate.

58. The packaging article of claim 57, wherein the first material comprises a photoinitiator selected from the group consisting of dibenzoyl biphenyl, substituted dibenzoyl biphenyl, benzoylated terphenyl, tribenzoyl triphenylbenzene, and benzoylated styrene oligomer.

59. The packaging article of claim 39, wherein the first material is blended during the exposing step.

60. The packaging article of claim 39, wherein the blow agent is a chemical blow agent, and wherein the agent is dissolved in a solvent and blended with the oxidizable organic polymer, and the blend comprising the solvent, the blow agent, and the oxidizable organic polymer is dried at a temperature below that sufficient to cause the blow agent to evolve gas in order to remove substantially all of the solvent, thereby producing the first material.

61. An article comprising:
a polymeric structure having micro-voids therein, wherein the structure comprises an oxidizable organic polymer, wherein the oxidizable organic polymer comprises a polymeric backbone and a plurality of pendant groups having the formula (I) 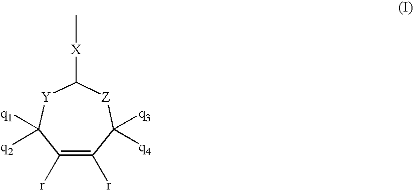
wherein X is a C₁-C₁₂ alkyl; a substituted C₁-C₁₂ alkyl; a C₁-C₁₂ ester; a C₁-C₁₂ ether; a C₁-C₁₂ silicone; or a group with the structure —(CH₂)ₙ—M—(CH₂)ₘ, wherein M is a linkage comprising oxygen, nitrogen, sulfur, silicon, or any combination thereof; n is from 0 to 12, inclusive; and m is from 0 to 12, inclusive, provided that when one of n or m is 0, the other is at least 1; Y is —(CRR′)ₐ—, wherein a is 0, 1, or 2; and Z is —(CRR′)_{b}—, wherein b is 0, 1, or 2, provided that 1≦a+b≦3; and q₁, q₂, q₃, q₄, r, R, and R′ are independently selected from hydrogen; linear, branched, cyclic, or polycyclic C₁-C₂₀ alkyl; aromatic groups; halogens; amines; or sulfur-containing substituents.

62. The article of claim 61, wherein the structure has a density less than about 0.7 g/cm³.

63. The article of claim 61, wherein the micro-voids have an average diameter of between about 1 micron and 20 microns, and wherein the cells comprise open cells, closed cells, or both.
